(19) United States
(12) Patent Application Publication
(10) Pub. No.: US 2008/0302990 A1
(43) Pub. Date: Dec. 11, 2008

(54) Air Lock for Pressure Vessels for Human Occupancy

(76) Inventor: Robert Bartlett, Metairie, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/626,648

(22) Filed: Jan. 24, 2007

(51) Int. Cl. F16K 31/44

(52) U.S. Cl. 251/213

(57) ABSTRACT

What is provided is an interlocking vent valve which when mounted on the body of the air lock is connected to a moving interlock pin with a linkage. When the interlock valve is closed the connected interlock pin extends through a hole in the body ring. The interlock pin blocks the path which the door ring lug must follow in order to open. In order to open the exterior door of the air lock, the operators must retract the interlock pin. The action which retracts the interlock pin also opens the interlock/vent valve which allows the pressure in the interlock to rapidly vent.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND

When a diver ascends from a deep dive he must go through a decompression cycle. In order to extend the bottom time for professional divers, decompression chambers on the deck of the dive boat are used so that the diver can use more of his self contained air at his working depth. Dive chambers are examples of a category of pressure vessel referred to as a PVHO (i.e.,—pressure vessel for human occupancy).

While the diver is in the decompression chamber, if medicines or supplies must be passed to the diver, an air lock must be used. The air lock on a dive chamber consists of a steel tube which penetrates the wall of the dive chamber. The steel tube has a door called a “closure” on each end. An air lock on a pressure vessel for human occupancy (e.g.—a decompression chamber) should be able to be operated quickly and easily, should be able to accommodate moderate wear without catastrophic failure and should have an interlock so that the operator's actions are reasonably constrained. If the closure is economical that is an advantageous feature also.

### BRIEF SUMMARY

The apparatus of the present invention solves the problems confronted in the art in a simple and straightforward manner. What is provided is an “Improved Air Lock for Pressure Vessels for Human Occupancy.

The drawings constitute a part of this specification and include exemplary embodiments to the invention, which may be embodied in various forms.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a side view of an exterior door.

FIG. 2 is a schematic view of the general arrangement of interlock and linkage.

FIG. 3 is a side view of an interior door.

### DETAILED DESCRIPTION

Detailed descriptions of one or more preferred embodiments are provided herein. It is to be understood, however, that the present invention may be embodied in various forms.

Therefore, specific details disclosed herein are not to be interpreted as limiting, but rather as a basis for the claims and as a representative basis for teaching one skilled in the art to employ the present invention in any appropriate system, structure or manner.

### Exterior Closure:

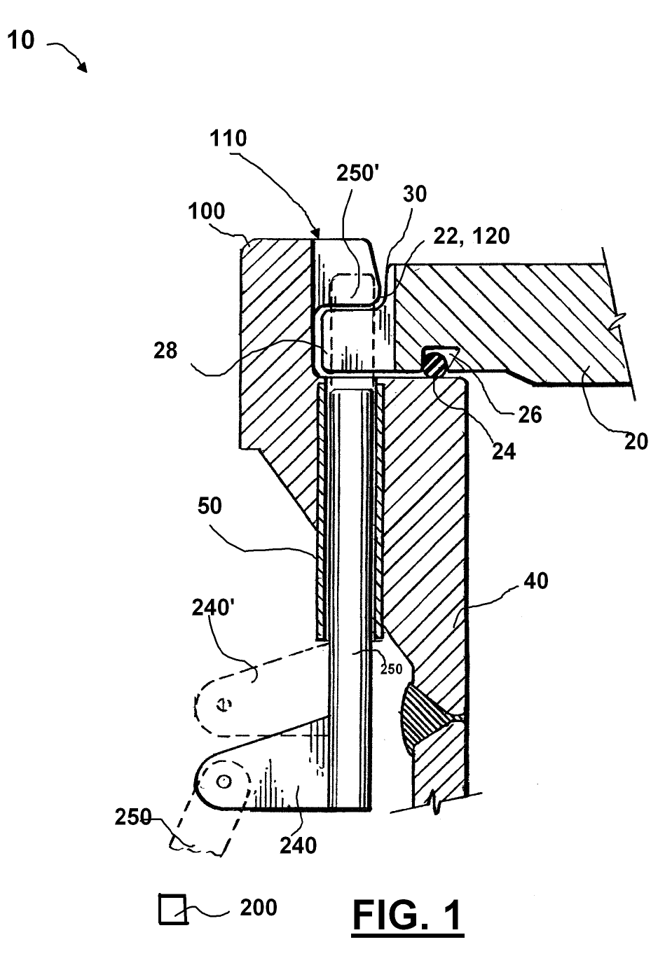

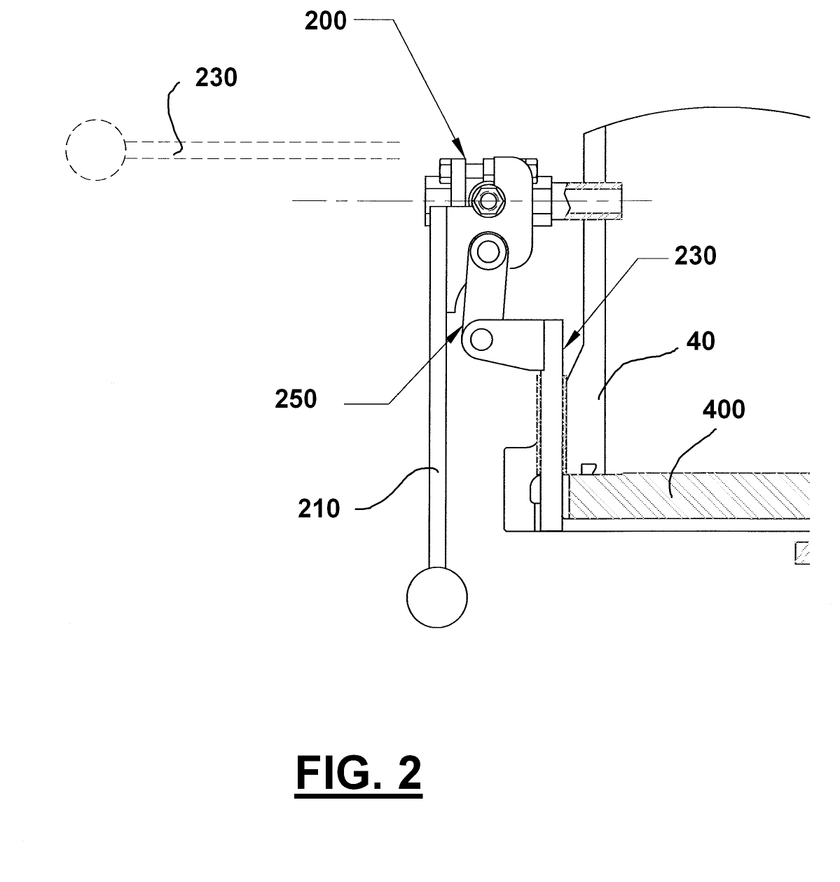

FIG. 1 is a side view of an exterior closure 10. FIG. 2 is a schematic view of the general arrangement of interlock and linkage 10.

The exterior closure must withstand the internal pressure of the dive chamber when the inner door is open. A device called a quick opening closure is suitable for this purpose. An economical choice for this small diameter application is a breech-lock type “two-ring” design familiar to those skilled in the art of quick opening closures. A two-ring style door uses a body ring welded to the body of the air lock and a “moving ring” which is the door. The door ring has radial lugs pointing outward. The body ring has radial lugs pointing inward. When the door ring is swung into the body ring and rotated, the door lugs engage their companion lugs on the body ring. Because the mating surfaces of these lugs are sloped, the relative rotational motion of the lugs on the two rings cause the door ring to be drawn toward the body ring, and thereby energize the seal which is between the two rings. Two-ring closures are in contrast to “three-ring” closures in which the door and body ring are non-rotating, but a third ring outside of those two rings (a lock ring) rotates to engage mating lugs on the door and/or body ring and thereby affect a seal.

Compared to three-ring closures, two-ring closures in general benefit from not having the expense of the third ring, not requiring lubrication of the sliding surfaces of a third ring, and not having their high stress areas hidden under a third ring. These advantages are particularly useful in a competitive commercial application such as a dive chamber where the closure is subjected to accelerated aging caused by an outdoor marine environment.

Two ring doors are not without their problems. On of the hazards associated with any manually operated quick opening closure is that the operator can attempt to operated the closure while it is under pressure. The general methods used to prevent two ring doors from being opened while under pressure rely on indicators or interlocks.

Examples of “indicators” are pressure gage or pressure actuated spring loaded pop-up piston. Indicators only notifying the operator and depend on his recognizing and acting on the information which the indicator is presenting. Also, spring loaded piston indicators retract when a small pressure still remains in the chamber so that a false “OK” signal can be communicated.

An interlock is a device which constrains the operator from opening the door until after a vent has been opened. An example of a previous solution for a two-ring door would be a vent plug in the door which is chained to a stationary part of the vessel. Compared to three-ring closures, small two ring closures are more of a design challenge to interlock because the motion of the door needs to be constrained relative to the venting of the chamber. “Vent plug-on-chin” interlocks constrain behavior, but they are slow and awkward.

I have claim to have developed an interlocking vent valve which when mounted on the body of the air lock is connected to a moving interlock pin with a linkage. When the interlock valve is closed the connected interlock pin extends through a hole in the body ring. The interlock pin blocks the path which the door ring lug must follow in order to open. In order to open the exterior door of the air lock, the operators must retract the interlock pin. The action which retracts the interlock pin also opens the interlock/vent valve which allows the pressure in the interlock to rapidly vent.

Another disadvantage of two-ring doors is related to the door support required because the door not only swings out, but also rotates about its axis. Because of this, the a two-ring door hinge typically connects to the door via a bearing in the hinge blade which supports an axle in the center of the door. Bearings eventually wear and that allows alignments to change. This alignment is relevant because O-rings seals containment in a cavity with limited gaps to prevent a form of failure referred to as “extrusion”. Extrusion failure of O-rings and the design gap sizes required to prevent it are described in O-ring design handbooks such as the “parker O-Ring Handbook” and are familiar to those skilled in the art of O-ring joint design. For a closure where human life depends on its proper operation, a concentricity misalignment of the door which leads to a gap and possible extrusion failure is un-acceptable. One solution as shown FIG. 1 is to control the geometry of the door such that it has a raised center on the outside which has a diameter only slightly less than the inside diameter of the tips of the body ring teeth. This constraint prevents the door from moving out of concentricity even if the center bearing wears or if the hinge is caused to become misaligned in such a way that a door concentricity error would otherwise be created.

A preferred embodiment of the O-ring groove is a single dovetail groove where the sloping side of the groove is toward the inside. The O-ring is then sized to be 1½ percent smaller than the theoretical size so that it stays in the groove when the door is opened.

### Interior Door:

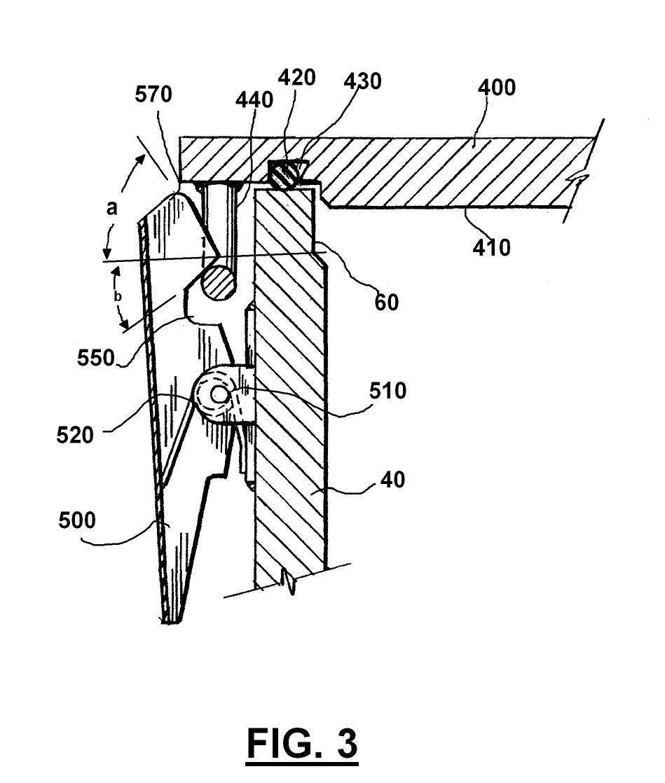

FIG. 3 is a side view of an interior door 400.

Another problem with dive chamber air locks relates to the operation of the inner closure or door. The inner door swings inwards. As a result a pressure differential between the living space and the air lock chamber presses the inner door against the seal between it and the air lock body tube. The air lock inner door, therefore, does not need a closing mechanism when a pressure difference exists. However, dive chambers are utilized on ships which can have large motions, and they are frequently open and closed and cause damage to itself. Also, while on the deck of a vessel that is listing (for example while discharging a portion of its cargo) an unlatched inner door can swing open on its own. If the inner door does open by itself when the dive chamber is pressurized but unoccupied, the operator standing outside cannot reach through the outer door to close the inner door because the pressure on the air lock outer door cannot be isolated from the pressure in the dive chamber. The inconvenient remedy is to release the pressure in the dive chamber so that the problem can be addressed. A seemingly simple solution is a swing bolt latch or other clamping latch on this inner door. But, this had the disadvantage that it can hold the door closed and trap pressure inside the air lock as the living space of the dive chamber is reduced during the depressurization treatment. Such a condition could lead to the explosive release of the inner door upon the failure of this latch. A unique and novel solution which I developed I the use of a simple, rugged economical spring loaded latch which holds the inner door securely closed during shipment, but which also the inner door to temporarily lift off of the seal and thereby vent any differential pressure which may exist in the air lock.

The preferred embodiment of this latch is shown in the FIG. 1. The latch has several characteristic features that allow it to perform these functions. When the door is in the closed position the staple bears on the inside of the latch hook whose angle combined with the spring force causes the door to close against the door seal. In the even of a pressure differential attempting to open the door, the latch allows the door to lift off of the seal to vent the pressure. The spring and sloping contact surface of the latch pull the door closed again after the pressure is released. The latch also allows the door to be closed without manually depressing the latch because the slope of the latch tip combined with its spring action allow the latch to clasp the staple when the door is pressed closed.

The inner door uses an O-ring as a seal for the same reasons as the outer door. Others have put the O-ring groove in the end of the tube. The disadvantage of that is that if the groove becomes damages, the air lock needs to be cut out of the vessel to be re-machined or a very expensive in-place machining operation must be performed if it is available. Our solution is to put the O-ring groove in the door. The sealing face on the body tube is now merely flat. For this reason is less likely to become damaged, and if damaged it can be repaired using manual methods (e.g.—hand file). The O-ring groove can now be easily repaired because the door can be removed and taken to a machine shop. Placing the O-ring groove in the door creates a condition that must be considered, though. If the door moves out of position, a gap can be created in the O-ring groove which could allow the O-ring to fail in extrusion as described above. The solution is to bore the inside of the end of the air lock tube and create a raised center on the door. The raised center of the door registers in the bore of the tube so that the door must be in positioned correctly when the door is closed. This is illustrated in FIG. 3.

The concerns regarding extrusion of an O-ring from a groove in which an excessive gap is allowed exists for this door also. To address this the apparatus of FIG. 2 is provided.

The following is a list of reference numerals:

LIST FOR REFERENCE NUMERALS

| (Reference No.) | (Description) |
|---|---|
| 10 | apparatus |
| 20 | door |
| 22 | sloped/mating surface |
| 24 | O-ring |
| 26 | groove |
| 28 | lug |
| 30 | raised center with sloped/mating surface |
| 40 | body tube |
| 50 | stainless steel sleeve |
| 60 | bored portion |
| 100 | body rings |
| 110 | lug |
| 120 | tip with sloped/mating surface |
| 200 | interlocking valve |
| 210 | locked position - vent closed and pin engaged |
| 220 | unlocked position - - vent open and pin retracted |
| 230 | interlock pin |
| 240 | link connector |
| 250 | pivoting link |
| 400 | door |
| 410 | raised center |
| 420 | O-ring |
| 430 | groove |
| 440 | staple |
| 500 | latch |
| 510 | pivot point |
| 520 | torsion spring |
| 550 | recess |
| 560 | angle of recess |
| 570 | tip |
| 580 | angle of tip |
| a | angle 60 degrees |
| b | angle 45 degrees |

What I claim is:

1. An interlocking vent valve comprising:
(a) a decompression chamber having an interior;
(b) a portal fluidly having an interior, the interior being fluidly connected to the interior of the decompression chamber; and
(c) a door connected to the portal, the door having an interlock valve fluidly connected to the interior of the portal, the interlock valve having a pin having open and closed states, wherein opening of the interlock valve vents the interior of the portal and also moves the pin from a locked to an unlocked state, wherein when in a locked state the door cannot be opened and when in an unlocked state the door can be opened.
